(19) United States
(12) Patent Application Publication
(10) Pub. No.: US 2025/0197557 A1
(43) Pub. Date: Jun. 19, 2025

(54) EPOXY RESIN B-STAGE FILM, EPOXY RESIN CURED FILM AND METHOD OF PRODUCING EPOXY RESIN CURED FILM

(71) Applicant: RESONAC CORPORATION, Tokyo (JP)

(72) Inventors: Shingo TANAKA, Tokyo (JP); Yoshitaka TAKEZAWA, Tokyo (JP); Kazuya KIGUCHI, Tokyo (JP)

(21) Appl. No.: 19/053,171

(22) Filed: Feb. 13, 2025

Related U.S. Application Data
(62) Division of application No. 17/312,401, filed on Jun. 10, 2021, now abandoned.

(51) Int. Cl. C08G 59/24; C08G 59/50; C08J 5/18

(52) U.S. Cl. CPC C08G 59/245; C08G 59/5033; C08J 5/18; C08J 2363/00

(57) ABSTRACT

An epoxy resin B-stage film obtained by semi-curing an epoxy resin composition, the epoxy resin composition including: a liquid crystalline epoxy monomer capable of forming a cured product that includes a liquid crystal structure; and a curing agent, in which the epoxy resin B-stage film has an average thickness of less than 8 μm, and in which the liquid crystal structure included in the cured product turns into a liquid crystal structure, in which molecules are orientated in a film thickness direction, by being cured.

### CROSS-REFERENCE TO RELATED APPLICATIONS

This application is a divisional application of, and claims priority to, U.S. patent application Ser. No. 17/312,401, filed Jun. 10, 2021, which is a National Stage Entry of International Application No. PCT/JP2018/045517, filed on Dec. 11, 2018, the disclosures of which are incorporated herein by reference in their entireties.

### TECHNICAL FIELD

The invention relates to an epoxy resin B-stage film, an epoxy resin cured film and a method of producing an epoxy resin cured film.

### BACKGROUND ART

In recent years, a high thermal conductivity has been required for insulating materials included in electronic devices, because there is a tendency for an increase in the amount of heat generated per unit volume associated with an increase in energy density due to downsizing and higher performance of electronic devices. Epoxy resins are conventionally used in insulating materials, because of their high withstand voltage and ease of forming. In order to enhance the thermal conductivity of an epoxy resin, a method is commonly used in which a filler having a high thermal conductivity and having insulating properties is added to the resin. Examples of the filler having a high thermal conductivity and having insulating properties include alumina particles.

WO 2013/065758 discloses that the combination of a liquid crystalline epoxy resin and alumina particles allows the liquid crystalline epoxy resin to form a higher-order structure on an alumina surface, and the higher-order structure forms a thermal conduction path in such a manner to connect the alumina particles, thereby enabling to enhance the thermal conductivity.

Further, as an insulating composition which has electrical insulating properties and an excellent thermal conductivity, Japanese Patent Application Laid-Open (JP-A) No. H11-323162 discloses an insulating composition which contains, as an essential component, a liquid crystalline resin obtained by polymerizing a resin composition containing a monomer having a mesogenic group. JP-A No. H11-323162 describes that the insulating composition may contain an inorganic ceramic having an excellent thermal conductivity, such as aluminum oxide.

### SUMMARY OF INVENTION

### Technical Problem

However, there is a case in which a thin film cannot be formed by a method of filling a filler having insulating properties. The development of a material is desired, which allows for exhibiting an excellent thermal conductivity even when formed into a thin film.

In view of the above mentioned problems, an object of the present invention is to provide: an epoxy resin B-stage film which is capable of forming an epoxy resin cured film having an excellent thermal conductivity; an epoxy resin cured film having an excellent thermal conductivity; and a method of producing an epoxy resin cured film.

### Solution to Problem

The means for solving the problem include the follow embodiments.

<1> An epoxy resin B-stage film obtained by semi-curing an epoxy resin composition, the epoxy resin composition including: a liquid crystalline epoxy monomer capable of forming a cured product that includes a liquid crystal structure; and a curing agent,
wherein the epoxy resin B-stage film has an average thickness of less than 8 μm, and
wherein the liquid crystal structure included in the cured product turns into a liquid crystal structure, in which molecules are orientated in a film thickness direction, by being cured.

<2> The epoxy resin B-stage film according to <1>, wherein the liquid crystalline epoxy monomer includes a monomer represented by the following Formula (I):

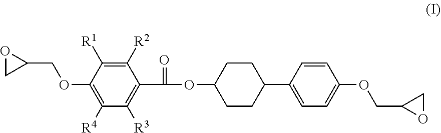

wherein, in Formula (I), each of R¹ to R⁴ independently represents a hydrogen atom or an alkyl group having from 1 to 3 carbon atoms.

<3> The epoxy resin B-stage film according to <2>, wherein the liquid crystalline epoxy monomer includes a reaction product of the monomer represented by Formula (I) and at least one selected from the group consisting of hydroquinone and a biphenol.

<4> The epoxy resin B-stage film according to any one of <1> to <3>, wherein the curing agent includes an amine curing agent.

<5> An epoxy resin cured film, including a liquid crystal structure in which molecules are orientated in a film thickness direction, and which has an average thickness of less than 8 μm.

<6> The epoxy resin cured film according to <5>, wherein the liquid crystal structure is a nematic structure or a smectic structure.

<7> The epoxy resin cured film according to <5> or <6>, including a cured product of an epoxy resin composition, the epoxy resin composition including: a liquid crystalline epoxy monomer capable of forming a cured product that includes a liquid crystal structure; and a curing agent.

<8> The epoxy resin cured film according to <7>, wherein the liquid crystalline epoxy monomer includes a monomer represented by the following Formula (I):

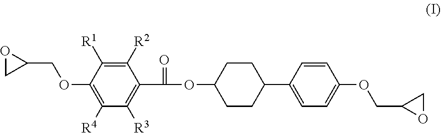

wherein, in Formula (I), each of R¹ to R⁴ independently represents a hydrogen atom or an alkyl group having from 1 to 3 carbon atoms.

<9> The epoxy resin cured film according to <8>, wherein the liquid crystalline epoxy monomer includes a reaction product of the monomer represented by Formula (I) and at least one selected from the group consisting of hydroquinone and a biphenol.

<10> The epoxy resin cured film according to any one of <7> to <9>, wherein the curing agent includes an amine curing agent.

<11> The epoxy resin cured film according to <5> or <6>, which is a cured product of the epoxy resin B-stage film according to any one of <1> to <4>.

<12> A method of producing an epoxy resin cured film, the method including:
a step of forming a film having an average thickness of less than 8 μm at a temperature of 150° C. or lower, using an epoxy resin composition including: a liquid crystalline epoxy monomer capable of forming a cured product that includes a liquid crystal structure; and a curing agent; and
a step of curing the film at a curing temperature of 200° C. or lower.

### Advantageous Effects of Invention

According to the invention, it is possible to provide: an epoxy resin B-stage film which is capable of forming an epoxy resin cured film having an excellent thermal conductivity; an epoxy resin cured film having an excellent thermal conductivity; and a method of producing an epoxy resin cured film.

### DESCRIPTION OF EMBODIMENTS

Embodiments for implementing the invention will now be described in detail. However, the invention is in no way limited to the following embodiments. In the following embodiments, constituent elements (including element steps and the like) of the embodiments are not essential, unless otherwise specified. Likewise, numerical values and ranges thereof are not intended to restrict the invention.

In the present disclosure, the definition of the term “step” includes not only an independent step which is distinguishable from another step, but also a step which is not clearly distinguishable from another step, as long as the purpose of the step is achieved.

In the present disclosure, any numerical range described using the expression “to” represents a range in which numerical values described before and after the “to” are included in the range as a minimum value and a maximum value, respectively.

In a numerical range described in stages, in the present disclosure, an upper limit value or a lower limit value described in one numerical range may be replaced with an upper limit value or a lower limit value in another numerical range described in stages. Further, in a numerical range described in the present disclosure, the upper limit value or the lower limit value in the numerical range may be replaced with a value shown in the Examples.

In the present disclosure, each component may include plural kinds of substances corresponding to the component. In a case in which plural kinds of substances corresponding to each component are present in a composition, the content ratio or content of each component refers to the total content ratio or content of the plural kinds of substances present in the composition, unless otherwise specified.

In the present disclosure, particles corresponding to each component may include plural kinds of particles. In a case in which plural kinds of particles corresponding to each component are present in a composition, the particle size of each component refers to the value of the particle size of a mixture of the plural kinds of particles present in the composition, unless otherwise specified.

In the present disclosure, the term “membrane” comprehends herein not only a case in which the membrane is formed over the whole observed region where the membrane is present, but also a case in which the membrane is formed only on part of the region.

In the present disclosure, the average thickness is determined by measuring the thickness of an object at arbitrarily selected five locations and calculating an arithmetic mean value of the measured thickness. Thickness can be measured using a micrometer or the like.

### Epoxy Resin B-Stage Film

An epoxy resin B-stage film according to the present disclosure (hereinafter, sometimes simply referred to as “B-stage film”) is a film obtained by semi-curing an epoxy resin composition, the epoxy composition including: a liquid crystalline epoxy monomer capable of forming a cured product that includes a liquid crystal structure; and a curing agent, wherein the epoxy resin B-stage film has an average thickness of less than 8 μm, and wherein the liquid crystal structure included in the cured product turns into a liquid crystal structure, in which molecules are orientated in the film thickness direction, by being cured.

It is thought that a cured product of the B-stage film has an improved thermal conductivity, by configuring the B-stage film to have the constitution described above. The B-stage film may further contain another component.

In the present disclosure, the terms “A stage” and “B stage” refer to those defined in JIS K6900: 1994. Since unreacted portions of the liquid crystalline epoxy monomer and the curing agent are remaining in the B-stage film, the B-stage film can be cured by heating the film.

In the present disclosure, the expression “to semi-cure” an epoxy resin composition refers to heating the epoxy resin composition to allow the reaction to proceed up to the B stage.

The B-stage film has an average thickness of less than 8 μm, preferably 7 μm or less, and more preferably 6 μm or less, and still more preferably 5 μm or less.

The components of the epoxy resin composition as the material of the epoxy resin B-stage film will now be described in detail.

The epoxy resin composition to be used in the present disclosure includes: a liquid crystalline epoxy monomer capable of forming a cured product including a liquid crystal structure; and a curing agent; and may contain another component, if necessary.

### Liquid Crystalline Epoxy Monomer

The epoxy resin composition contains a liquid crystalline epoxy monomer capable of forming a cured product including a liquid crystal structure. Such a liquid crystalline epoxy monomer may be, for example, a monomer having a mesogenic structure (such as a biphenyl group, a cyclohexylphenyl group, a terphenyl group, a terphenyl analog group, an anthracene group, or a group in which any of these groups are connected via an azomethine group or an ester group). When a liquid crystalline epoxy monomer having a mesogenic structure reacts with a curing agent to form a cured product (sometimes referred to as “resin matrix”), a higher-order structure (also referred to as “periodic structure”) derived from the mesogenic structure is formed in the resin matrix.

The higher-order structure (periodic structure) as used in the present disclosure refers to a state in which molecules are oriented in a resin matrix, for example, a state in which a crystal structure or a liquid crystal structure is present in a resin matrix. The presence of such a crystal structure or liquid crystal structure can be directly confirmed, for example, by observation using a polarizing microscope under crossed Nicols, or X-ray scattering. Further, since changes in the storage modulus of the resin with respect to the temperature is reduced when a crystal structure or a liquid crystal structure is present, the presence of the crystal structure or the liquid crystal structure can be indirectly confirmed, by measuring the changes in the storage modulus of the resin with respect to the temperature.

Examples of the higher-order structure with a high regularity which is derived from a mesogenic structure include a nematic structure and a smectic structure. The nematic structure is a liquid crystal structure in which major axes of molecules are oriented in a similar direction, and which has only an orientational order. In contrast, the smectic structure is a liquid crystal structure which has a positional order in the first dimension in addition to an orientational order, and which has a constant periodic layer structure. Further, in the identical layers constituting the periodic layer structure of the smectic structure, molecules constituting the respective layers in the periodic layer structure are oriented in a similar direction. The liquid crystal structure is preferably the nematic structure or the smectic structure.

The proportion of the liquid crystal structure with respect to the total amount of the resin matrix can easily be measured by observation using a polarizing microscope. Specifically, the proportion of the liquid crystal structure with respect to the total amount of the resin matrix can easily be measured, by observing a cured product using a polarizing microscope (such as “OPTIPHOT2-POL” (product name), manufactured by NIKON Corporation) to measure the area of the liquid crystal structure, and by determining the percentage with respect to the area of the entire visual field observed with the polarizing microscope.

From the viewpoint of the formation of the liquid crystal structure, the liquid crystalline epoxy monomer preferably includes a monomer represented by the following Formula (I). The monomer represented by the following Formula (I) may be used singly, or in combination of two or more kinds thereof.

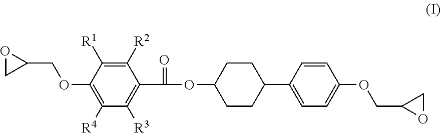

In Formula (I), each of R¹ to R⁴ independently represents a hydrogen atom or an alkyl group having from 1 to 3 carbon atoms. It is preferred that each of R¹ to R⁴ independently represents a hydrogen atom or an alkyl group having from 1 to 2 carbon atoms, more preferably a hydrogen atom or a methyl group, and still more preferably a hydrogen atom. Further, it is preferred that from two to four of R¹ to R⁴ are hydrogen atoms, more preferably from three to four of R¹ to R⁴ are hydrogen atoms, and still more preferably all four of R¹ to R⁴ are hydrogen atoms. In a case in which any of R¹ to R⁴ is an alkyl group having from 1 to 3 carbon atoms, it is preferred that at least one of R¹ or R⁴ is an alkyl group having from 1 to 3 carbon atoms.

Examples of the monomer represented by Formula (I) are described, for example in JP-A No. 2011-74366. Specific examples of the monomer represented by Formula (I) include 4-{4-(2,3-epoxypropoxy)phenyl}cyclohexyl=4-(2,3-epoxypropoxy)benzoate and 4-{4-(2,3-epoxypropoxy)phenyl}cyclohexyl-4-(2,3-epoxypropoxy)-3-methyl benzoate.

Examples of other liquid crystalline epoxy monomers include a biphenyl-type epoxy monomer, and a tricyclic epoxy monomer other than the monomer represented by Formula (I).

Examples of the biphenyl-type epoxy monomer include 4,4′-bis(2,3-epoxypropoxy)biphenyl, 4,4′-(2,3-epoxypropoxy)-3,3′,5,5′-tetramethylbiphenyl, and an epoxy monomer obtained by allowing epichlorohydrin to react with α-hydroxyphenyl-ω-hydropoly(biphenyldimethylene-hydroxyphenylene). Examples of biphenyl-type epoxy resins include those which are commercially available under the names of: “YX4000” and “YL6121H” (both of which are manufactured by Mitsubishi Chemical Corporation); and “NC-3000” and “NC-3100” (both of which are manufactured by Nippon Kayaku Co., Ltd.), and the like.

Examples of the tricyclic epoxy monomer include an epoxy monomer having a terphenyl skeleton, 1-(3-methyl-4-oxiranylmethoxyphenyl)-4-(4-oxiranylmethoxyphenyl)-1-cyclohexene, and 1-(3-methyl-4-oxiranylmethoxyphenyl)-4-(4-oxiranylmethoxyphenyl)-benzene.

The liquid crystalline epoxy monomer is preferably 4-{4-(2,3-epoxypropoxy)phenyl}cyclohexyl=4-(2,3-epoxypropoxy)benzoate or 1-(3-methyl-4-oxiranylmethoxyphenyl)-4-(4-oxiranylmethoxyphenyl)-1-cyclohexene.

At least a part of the liquid crystalline epoxy monomer may be in the form of a prepolymer obtained by the reaction with a prepolymer-forming agent to be described later. The prepolymer-forming agent is a compound which has a functional group capable of reacting with an epoxy group in the liquid crystalline epoxy monomer, and which is capable of multimerizing the liquid crystalline epoxy monomer so as to form a prepolymer.

Liquid crystalline epoxy monomers having a mesogenic structure within a molecular structure, including the monomer represented by Formula (I), are generally prone to crystallization, and many of these monomers have a lower solubility in a solvent as compared to other epoxy monomers. By polymerizing at least a part of the liquid crystalline epoxy monomer to form a prepolymer, there is a tendency that the crystallization of the monomer is reduced to improve the formability of the epoxy resin composition.

The prepolymer-forming agent may be the same as the curing agent to be described later, or may be another compound. Specifically, the prepolymer-forming agent is preferably a divalent phenol compound having two hydroxyl groups as substituents on one benzene ring, or a biphenol compound having two hydroxyl groups as substituents on two benzene rings. Examples thereof include: catechol, resorcinol and hydroquinone, and derivatives thereof; and biphenols such as 3,3′-biphenol and 4,4′-biphenol, and derivatives thereof. Examples of the derivatives include compounds in which a benzene ring is substituted with an alkyl group having from 1 to 8 carbon atoms or the like. Among these prepolymer-forming agents, it is preferred from the viewpoint of improving the thermal conductivity of the resulting formed product, to use at least one selected from the group consisting of hydroquinone, 3,3′-biphenol and 4,4′-biphenol, and more preferred to use 4,4′-biphenol. Since 4,4′-biphenol has a structure in which substitution has taken place such that positional relationship between two hydroxyl groups is point-symmetrical, a prepolymer obtained by reacting 4,4′-biphenol with a liquid crystalline epoxy monomer is more likely to have a linear structure. This is thought to result in improved molecular stacking properties, thereby facilitating the formation of a higher-order structure.

These prepolymer-forming agents may be used singly, or in combination of two or more kinds thereof.

In the present disclosure, the liquid crystalline epoxy monomer preferably includes a reaction product of the monomer represented by Formula (I) and at least one selected from the group consisting of hydroquinone and a biphenol, as a prepolymer, more preferably includes a reaction product of the monomer represented by Formula (I) and at least one selected from the group consisting of hydroquinone, 3,3′-biphenol and 4,4′-biphenol, as a prepolymer, and still more preferably includes a reaction product of the monomer represented by Formula (I) with 4,4′-biphenol, as a prepolymer.

The prepolymer is preferably one obtained by mixing the liquid crystalline epoxy monomer and the prepolymer-forming agent such that the equivalence ratio (epoxy groups/hydroxyl groups) of epoxy groups and hydroxyl groups is within the range of from 100/5 to 100/35, and allowing the reaction to occur. The equivalence ratio described above is more preferably within the range of from 100/15 to 100/30, and more preferably from 100/15 to 100/25.

The method of allowing the liquid crystalline epoxy monomer to react with the prepolymer-forming agent to synthesize a prepolymer is not particularly limited. Specifically, a prepolymer can be synthesized, for example, by dissolving the liquid crystalline epoxy monomer, the prepolymer-forming agent, and a reaction catalyst which is used if necessary, in a solvent, and stirring the resulting solution while heating.

Alternatively, a prepolymer can be synthesized, by mixing the liquid crystalline epoxy monomer, the prepolymer-forming agent, and a reaction catalyst which is used if necessary, without using a solvent, and stirring the resulting mixture while heating.

The solvent is not particularly limited, as long as the solvent is capable of dissolving the liquid crystalline epoxy monomer and the prepolymer-forming agent, and can be heated up to a temperature necessary for both the compounds to be reacted. Specific examples of the solvent include cyclohexanone, cyclopentanone, ethyl lactate, propylene glycol monomethyl ether, N-methylpyrrolidone, methyl cellosolve, ethyl cellosolve and propylene glycol monopropyl ether.

The amount of the solvent is not particularly limited, as long as the amount allows for dissolving the liquid crystalline epoxy monomer, the prepolymer-forming agent, and a reaction catalyst which is used if necessary, at a reaction temperature. Although solubility varies depending on the type of raw materials before the reaction, the type of the solvent and the like, the solution after the reaction tends to have a viscosity within a preferred range, for example, when the solvent is used in such an amount that the solid concentration in the charged components is within the range of from 20% by mass to 60% by mass.

The type of the reaction catalyst is not particularly limited, and it is possible to select a reaction catalyst which is appropriate from the viewpoint of reaction velocity, reaction temperature, storage stability and the like. Specific examples of the reaction catalyst include imidazole compounds, organic phosphorus compounds, tertiary amines, and quaternary ammonium salts. These reaction catalysts may be used singly, or in combination of two or more kinds thereof.

The amount of reaction catalyst is not particularly limited. From the viewpoint of the reaction velocity and the storage stability, the amount of reaction catalyst is preferably from 0.1 parts by mass to 1.5 parts by mass, and more preferably from 0.2 parts by mass to 1 part by mass, with respect to 100 parts by mass of the total mass of the liquid crystalline epoxy monomer and the prepolymer-forming agent.

In the case of synthesizing a prepolymer using the liquid crystalline epoxy monomer, all of the liquid crystalline epoxy monomer may be reacted to be formed into the form of a prepolymer, or a part of the liquid crystalline epoxy monomer may remain in the resulting prepolymer in the form of the monomer, without being reacted.

The synthesis of a prepolymer can be carried out using a flask, when performed in a small scale, and can be carried out using a reaction vessel, such as a synthesis tank, when performed in a large scale. A specific synthesis method is, for example, as follows.

First, the liquid crystalline epoxy monomer is introduced into a reaction vessel, a solvent is added, if necessary, and the resulting mixture is heated to a reaction temperature using an oil bath or a heating medium to dissolve the liquid crystalline epoxy monomer. To the resulting solution, the prepolymer-forming agent is added, followed by adding a reaction catalyst, if necessary, to initiate a reaction. Subsequently, the solvent is removed by distillation under reduced pressure, if necessary, to obtain a prepolymer.

The reaction temperature is not particularly limited as long as the temperature allows the reaction of an epoxy group in the liquid crystalline epoxy monomer with a functional group in the prepolymer-forming agent, which is capable of reacting with the epoxy group, to proceed. It is preferred that the reaction temperature is, for example, within the range of from 100° C. to 180° C., and more preferably within the range of from 100° C. to 150° C. When the reaction temperature is set to 100° C. or higher, there is a tendency that the period of time until the reaction is completed can further reduced. On the other hand, when the reaction temperature is set to 180° C. or lower, there is a tendency that the possibility of the occurrence of gelation can be reduced.

From the viewpoint of formability, the content of the liquid crystalline epoxy monomer is preferably from 5% by volume to 80% by volume, more preferably from 10% by volume to 70% by volume, still more preferably from 20% by volume to 60% by volume, and particularly preferably from 30% by volume to 50% by volume, with respect to the total solid content of the epoxy resin composition.

In the present disclosure, the content of the liquid crystalline epoxy monomer on volume basis, with respect to the total solid content, is defined as a value determined by the following Formula:

$$Content ( \% by volume ) of liquid crystalline epoxy monomer with respect to the total solid content = [ ( Bw / Bd ) / \{ ( Aw / Ad ) + ( Bw / Bd ) + ( Cw / Cd ) + ( Dw / Dd ) \} ] \times 100$$

In the above Formula, each variable is as follows.
Aw: mass composition ratio (% by mass) of filler to be used if necessary
Bw: mass composition ratio (% by mass) of liquid crystalline epoxy monomer
Cw: mass composition ratio (% by mass) of curing agent
Dw: mass composition ratio (% by mass) of other optional component(s) (excluding solvent)
Ad: specific gravity of filler to be used if necessary
Bd: specific gravity of liquid crystalline epoxy monomer
Cd: specific gravity of curing agent
Dd: specific gravity of other optional component(s) (excluding solvent)

The epoxy resin composition may further contain another epoxy monomer other than the liquid crystalline epoxy monomer. Examples of other epoxy monomers include: glycidyl ethers of phenol compounds such as bisphenol A, bisphenol F, bisphenol S, phenol novolac, cresol novolac and resorcinol novolac; glycidyl ethers of alcohol compounds such as butanediol, polyethylene glycol and polypropylene glycol; glycidyl esters of carboxylic acid compounds such as phthalic acid, isophthalic acid and tetrahydrophthalic acid; glycidyl-type (including methyl glycidyl-type) epoxy monomers such as those in which an active hydrogen atom bound to a nitrogen atom of aniline, isocyanuric acid or the like is substituted with a glycidyl group; alicyclic epoxy monomers such as vinylcyclohexene epoxide, 3,4-epoxycyclohexylmethyl-3,4-epoxycyclohexane carboxylate and 2-(3,4-epoxy)cyclohexyl-5,5-spiro(3,4-epoxy)cyclohexane-m-dioxane, which are obtained by epoxidizing an olefin bond within the molecule; epoxidized products of bis(4-hydroxy)thioether; glycidyl ethers of resins such as paraxylylene-modified phenol resins, metaxylylene-paraxylylene-modified phenol resins, terpene-modified phenol resins, dicyclopentadiene-modified phenol resins, cyclopentadiene-modified phenol resins, polycyclic aromatic ring-modified phenol resins and naphthalene ring-containing phenol resins; stilbene-type epoxy monomers; and halogenated phenol novolac-type epoxy monomers (however, liquid crystalline epoxy monomers among these monomers are excluded). These other epoxy monomers may be used singly, or in combination of two or more kinds thereof.

The content of the other epoxy monomer(s) is not particularly limited, and is preferably 0.3 or less, more preferably 0.2 or less, and still more preferably 0.1 or less, when the amount of the liquid crystalline epoxy monomer is taken as 1 on mass basis.

### Curing Agent

The epoxy resin composition contains a curing agent. The curing agent is not particularly limited, as long as the curing agent is a compound capable of undergoing a curing reaction with the liquid crystalline epoxy monomer. Specific examples of the curing agent include amine curing agents, acid anhydride curing agents, phenol curing agents, polymercaptan curing agents, polyaminoamide curing agents, isocyanate curing agents and block isocyanate curing agents. These curing agents may be used singly, or in combination of two or more kinds thereof.

The curing agent is preferably an amine curing agent or a phenol curing agent, and more preferably an amine curing agent, from the viewpoint of the transparency of a cured product of the epoxy resin composition.

Specific examples of the amine curing agent include 3,3′-diaminodiphenyl sulfone, 4,4′-diaminodiphenyl sulphone, 4,4′-diaminodiphenylmethane, 4,4′-diaminodiphenyl ether, 4,4′-diamino-3,3′-dimethoxybiphenyl, 4,4′-diaminophenylbenzoate, 1,5-diaminonaphthalene, 1,3-diaminonaphthalene, 1,4-diaminonaphthalene, 1,8-diaminonaphthalene, 1,3-diaminobenzene, 1,4-diaminobenzene, 4,4′-diaminobenzanilide and trimethylene-bis-4-aminobenzoate.

In the case of using a phenol curing agent as the curing agent, a curing accelerator may be used in combination, if necessary. By using a curing accelerator in combination, the epoxy resin composition can be cured more sufficiently. The type of the curing accelerator is not particularly limited, and the curing accelerator may be selected from those commonly used. Examples of the curing accelerator include imidazole compounds, phosphine compounds and borate salt compounds.

The content of the curing agent in the epoxy resin composition can be set as appropriate depending on the type of the curing agent to be incorporated, and the physical properties of the liquid crystalline epoxy monomer.

Specifically, the number of equivalent of functional groups in the curing agent is preferably from 0.005 equivalents to 5 equivalents, more preferably from 0.01 equivalents to 3 equivalents, and still more preferably from 0.5 equivalents to 1.5 equivalents, with respect to one equivalent of epoxy groups in the liquid crystalline epoxy monomer. When the number of equivalent of functional groups in the curing agent is 0.005 equivalents or more with respect to one equivalent of epoxy groups, there is a tendency that the curing rate of the liquid crystalline epoxy monomer can further be improved. Further, when the number of equivalent of functional groups in the curing agent is 5 equivalents or less with respect to one equivalent of epoxy groups, there is a tendency that the curing reaction can be more adequately controlled.

The chemical equivalent as used in the present disclosure refers, for example, when a phenol curing agent is used as the curing agent, to the number of equivalent of hydroxyl groups in the phenol curing agent with respect to one equivalent of epoxy groups, and when an amine curing agent is used as the curing agent, to the number of equivalent of active hydrogen atoms in the amine curing agent with respect to one equivalent of epoxy groups.

### Filler

The epoxy resin composition may contain a filler. Ceramic particles can be used as the filler, from the viewpoint of thermal conductivity and insulating properties. Examples of the ceramic particles include alumina particles, silica particles, magnesium oxide particles, boron nitride particles, aluminum nitride particles, and silicon nitride particles. The filler preferably contains at least one selected from the group consisting of alumina particles, boron nitride particles, aluminum nitride particles and magnesium oxide particles, and more preferably contains alumina particles. Alumina particles preferably contain alumina particles having a high crystallinity, and more preferably contain α-alumina particles.

In a case in which the filler contains alumina particles, it is preferred that a periodic structure of the smectic structure is formed in a direction vertical to the surfaces of the alumina particles, in a cured product of the epoxy resin composition, from the viewpoint of the thermal conductivity.

The filler preferably has a volume average particle size of from 0.01 μm to 1 μm from the viewpoint of the thermal conductivity, and more preferably has a volume average particle size of from 0.01 μm to 0.1 μm from the viewpoint of the transparency.

The volume average particle size of the filler as used herein is measured using a laser diffraction method. The measurement by the laser diffraction method can be performed using a laser diffraction/scattering particle size distribution measuring apparatus (for example, LS230, manufactured by Beckman Coulter Inc.). The volume average particle size of the filler in the epoxy resin composition, the B-stage film or the epoxy resin cured film, is measured using a laser diffraction/scattering particle size distribution measuring apparatus, after extracting the filler from the epoxy resin composition, the B-stage film or the epoxy resin cured film.

Specifically, the filler is extracted from the epoxy resin composition, the B-stage film or the epoxy resin cured film, using an organic solvent, nitric acid, aqua regia or the like, and the thus extracted filler is well dispersed in a dispersion medium using an ultrasonic disperser or the like, to prepare a dispersion liquid. The resulting dispersion liquid is measured using a laser diffraction/scattering particle size distribution measuring apparatus, to obtain a cumulative volume distribution curve. The volume average particle size of the filler contained in the epoxy resin composition, the B-stage film or the epoxy resin cured film is measured by determining the particle size (D50) corresponding to cumulative 50%, when the cumulative volume distribution curve is drawn from a small diameter side, as the volume average particle size.

From the viewpoint of facilitating the formation of a thin film of the epoxy resin composition, the content of the filler is preferably 20% by mass or less, more preferably 15% by mass or less, still more preferably 10% by mass or less, particularly preferably 1% by mass or less, and extremely preferably 0.1% by mass or less, with respect to the total solid content of the epoxy resin composition. The epoxy resin composition need not contain a filler.

### Other Component(s)

The epoxy resin composition may further contain a coupling agent, a dispersant, an elastomer, a release agent, a solvent and/or the like.

As the solvent, it is possible to use any of the organic solvents commonly used in techniques for producing various types of chemical products. Examples thereof include, acetone, isobutyl alcohol, isopropyl alcohol, isopentyl alcohol, ethyl ether, ethylene glycol monoethyl ether, xylene, cresol, chlorobenzene, isobutyl acetate, isopropyl acetate, isopentyl acetate, ethyl acetate, methyl acetate, cyclohexanol, cyclohexanone, 1,4-dioxane, dichloromethane, styrene, tetrachloroethylene, tetrahydrofuran, toluene, normal hexane, 1-butanol, 2-butanol, methanol, methyl isobutyl ketone, methyl ethyl ketone, methylcyclohexanol, methylcyclohexanone, chloroform, carbon tetrachloride and 1,2-dichloroethane.

### Method of Producing Epoxy Resin B-Stage Film

The B-stage film according to the present disclosure can be produced, for example, by forming the epoxy resin composition described above in the form of a film having an average thickness of less than 8 μm, followed by semi-curing. Example of the method of forming the epoxy resin composition in the form of a film having an average thickness of less than 8 μm include a bar coating method and a spin coating method. The spin coating method is preferred from the viewpoint of achieving uniform formation. The spin coating is preferably carried out at a spinning rate of from 50 rotations/min to 5000 rotations/min, more preferably from 100 rotations/min to 3,000 rotations/min, and still more preferably from 500 rotations/min to 2,500 rotations/min, but not particularly limited thereto.

The temperature for carrying out the spin coating is not particularly limited. However, the spin coating is preferably carried out at a temperature of 150° C. or lower, and more preferably 100° C. or lower, so that the curing of the epoxy resin composition does not proceed excessively.

The method of semi-curing a formed product obtained by forming the epoxy resin composition in the form of a film having an average thickness of less than 8 μm is not particularly limited. The formed product may be semi-cured by heating. The formed product can be heated with a heating apparatus, such as, for example, a high temperature tank or a hot plate.

Further, in the case of using the spin coating method, the formed product may be semi-cured by controlling the temperature and the time when performing the spin coating.

The B-stage film according to the present disclosure may be one obtained by forming the epoxy resin composition described above in the form of a film having an average thickness of less than 8 μm, on an oxide substrate having a favorable wettability with water (also referred to as hydrophilicity), such as a glass substrate or an alumina substrate. In the B-stage film formed on an oxide substrate having a favorable wettability with water, the liquid crystal structure included in the cured product is more likely to turn into a liquid crystal structure in which molecules are orientated in the film thickness direction, by being cured.

### Applications etc. of Epoxy Resin B-Stage film

The B-stage film according to the present disclosure has a high degree of orientation of molecules, and has an excellent thermal conductivity when formed into a cured product. Therefore, the epoxy resin B-stage film according to the present disclosure can be suitably used in heat radiating materials and the like for heat-generating electronic components mounted on various types of electric devices and electronic devices.

### Epoxy Resin Cured Film and Method of Producing the Same

An epoxy resin cured film according to the present disclosure is one which includes a liquid crystal structure in which molecules are orientated in the film thickness direction, and which has an average thickness of less than 8 μm. Since the liquid crystal structure included in the epoxy resin cured film is a liquid crystal structure in which molecules are orientated in the film thickness direction, the epoxy resin cured film according to the present disclosure has an excellent thermal conductivity.

Whether or not the liquid crystal structure is one in which molecules are orientated in the film thickness direction can be determined by conoscopic observation with a polarizing microscope. Specifically, in the observation using a polarizing microscope (such as “OPTIPHOT2-POL” (product name) manufactured by NIKON Corporation) with the epoxy resin cured film disposed under crossed Nicols, when a dark filed image is obtained by orthoscopic observation and a Maltese cross can be observed by the conoscopic observation, it indicates that molecules are orientated in the film thickness direction.

The epoxy resin cured film according to the present disclosure has an average thickness of less than 8 μm. When the epoxy resin cured film has an average thickness of less than 8 μm, molecules are more likely to be orientated in the film thickness direction, resulting in an excellent thermal conductivity in the film thickness direction. Further, when the epoxy resin cured film has an average thickness of less than 8 μm, the probability of the occurrence of defects such as disturbances in the orientation of molecules is reduced, and thus, the thermal conductivity tends to be enhanced stably.

The epoxy resin cured film according to the present disclosure may be a cured product obtained by curing the epoxy resin B-stage film according to the present disclosure or the epoxy resin composition described above.

The epoxy resin cured film according to the present disclosure may be one obtained by a method of producing an epoxy resin cured film according to the present disclosure, the method including:
a step of forming a film having an average thickness of less than 8 μm at a temperature of 150° C. or lower, using an epoxy resin composition including: a liquid crystalline epoxy monomer capable of forming a cured product including a liquid crystal structure; and a curing agent (hereinafter, sometimes referred to as “film forming step”); and
a step of curing the film at a curing temperature of 200° C. or lower (hereinafter, sometimes referred to as “curing step”).

In the film forming step, it is possible to form a film using the epoxy resin composition, by a bar coating method, a spin coating method or the like. The film formed in the film forming step may be a B-stage film, or may be an A-stage film, which is in a state where the curing of the liquid crystalline epoxy monomer contained in the film has not been proceeded.

In order to form a liquid crystal structure in which molecules are orientated in the film thickness direction, it is preferred to form a film on an oxide substrate having a favorable wettability with water (also referred to as hydrophilicity), such as a glass substrate or an alumina substrate, and to cure the film on such a substrate.

The curing temperature in the curing step can be set depending on the components of the epoxy resin composition, and is, for example, preferably 200° C. or lower, and more preferably 180° C. or lower. Further, the curing is carried out, for example, for a curing time of preferably from 1 hour to 5 hours, and more preferably from 2 hours to 4 hours, but not particularly limited thereto. It is also preferred to further subject the epoxy resin cured film to a heat treatment (hereinafter, also referred to as “post-curing”). The post-curing tends to result in a further improvement in crosslinking density. As described above, the heat treatment may be performed two or more times.

The heating apparatus to be used for the heat treatment is not particularly limited, and it is possible to use a heating apparatus commonly used. The post-curing is carried out, for example, at a temperature of preferably from 60° C. to 100° C., and more preferably from 80° C. to 100° C., but not particularly limited thereto. Further, the post-curing is carried out, for example, for a period of time of preferably from 10 minutes to 600 minutes, and more preferably 60 minutes to 300 minutes, but not particularly limited thereto.

### EXAMPLES

The invention will now be described in specific detail, with reference to Examples. It is noted, however, that the invention is in no way limited to these Examples. The terms “part(s)” and “%” are used on a mass basis, unless otherwise specified.

### Example 1

A liquid crystalline epoxy monomer (4-{4-(2,3-epoxypropoxy)phenyl}cyclohexyl=4-(2,3-epoxypropoxy)benzoate, a monomer represented by Formula (I) (hereinafter, also referred to as “resin 1”) was allowed to react with 4,4′-biphenol in advance to obtain a prepolymer (hereinafter, also referred to as “resin 2”), and the thus formed prepolymer and a curing agent (3,3′-diaminodiphenyl sulfone) were mixed to prepare an epoxy resin composition. The content of the liquid crystalline epoxy monomer was about 35% by volume, with respect to the total solid content of the epoxy resin composition.

The step of synthesizing the resin 2 will be described later.

The amounts of the liquid crystalline epoxy monomer and the curing agent to be incorporated were adjusted such that the ratio (epoxy groups: active hydrogen atoms) of the number of equivalent of epoxy groups in the liquid crystalline epoxy monomer and the number of equivalent of active hydrogen atoms in the curing agent was 1:1.

The thus prepared epoxy resin composition was spin coated on a glass substrate at 2,000 rotations/min and at 90° C. The coated substrate was subjected to curing at 150° C. for 4 hours to cure the epoxy resin composition, followed by etching the glass substrate with hydrofluoric acid, to obtain an epoxy resin cured film.

The thermal diffusivity of the resulting epoxy resin cured film was measured using a thermal diffusivity measuring apparatus, TA3, manufactured by Bethel Inc. Subsequently, the measured result was multiplied by the value of density measured by an Archimedes method and the value of specific heat measured by a DSC method, to determine the thermal conductivity of the epoxy resin cured film in the thickness direction thereof. The presence or absence of a liquid crystal structure in the epoxy resin cured film, and the direction of orientation thereof were measured using “OPTIPHOT2-POL” (product name), manufactured by NIKON Corporation. The average thickness of the epoxy resin cured film was determined using a micrometer. The thus obtained results are shown in Table 1.

### <Synthesis of Resin 2>

Into a 500 mL three-neck flask, 50 g of the resin 1 was weighed, and 80 g of propylene glycol monomethyl ether as a solvent was added thereto. A cooling pipe and a pipe for introducing nitrogen were connected to the three-neck flask, and a stirring blade was attached to the flask so as to be immersed in the solvent. The three-neck flask was immersed in an oil bath controlled to 120° C., and stirring was initiated. After confirming that the resin 1 had dissolved and the solution turned transparent, 4,4′-biphenol was added to the flask such that the equivalence ratio (epoxy groups/hydroxyl groups) of epoxy groups and hydroxyl groups was 100/25. To the resultant, 0.5 g of triphenylphosphine as a reaction catalyst was added, and the heating at an oil bath temperature of 120° C. was continued. After continuing the heating for 3 hours, propylene glycol monomethyl ether was removed from the reaction solution by distillation under reduced pressure, and residues were cooled to room temperature (25° C.) to obtain a liquid crystalline epoxy monomer (resin 2) in a state in which a part of the resin 1 had reacted with 4,4′-biphenol to form a multimer (prepolymer).

### Example 2

The same operation as in Example 1 was carried out except that hydroquinone was used instead of 4,4′-biphenol used in Example 1, to synthesize a prepolymer (hereinafter, also referred to as “resin 3”). The content of the liquid crystalline epoxy monomer was about 35% by volume, with respect to the total solid content of the epoxy resin composition.

### Example 3

The same operation as in Example 1 was carried out except that a liquid crystalline epoxy monomer (1-(3-methyl-4-oxiranylmethoxyphenyl)-4-(4-oxiranylmethoxyphenyl)-1-cyclohexene) (hereinafter, also referred to as “resin 4”) was used instead of the resin 1 used in Example 1, to synthesize a prepolymer (hereinafter, also referred to as “resin 5”). The content of the liquid crystalline epoxy monomer was about 35% by volume, with respect to the total solid content of the epoxy resin composition.

### Example 4

The same operation as in Example 2 was carried out except that the resin 4 was used instead of the resin 1 used in Example 2, to synthesize a prepolymer (hereinafter, also referred to as “resin 6”). The content of the liquid crystalline epoxy monomer was about 35% by volume, with respect to the total solid content of the epoxy resin composition.

### Example 5

The same operation as in Example 1 was carried out except that 100 parts of a solvent (tetrahydrofuran) was added, in addition, with respect to 100 parts of the resin 2, to prepare an epoxy resin composition.

### Example 6

The same operation as in Example 2 was carried out except that 100 parts of a solvent (tetrahydrofuran) was added, in addition, with respect to 100 parts of the resin 3, to prepare an epoxy resin composition.

### Example 7

The same operation as in Example 3 was carried out except that 100 parts of a solvent (tetrahydrofuran) was added, in addition, with respect to 100 parts of the resin 5, to prepare an epoxy resin composition.

### Example 8

The same operation as in Example 4 was carried out except that 100 parts of a solvent (tetrahydrofuran) was added, in addition, with respect to 100 parts of the resin 6, to prepare an epoxy resin composition.

### Comparative Example 1

The same operation as in Example 1 was carried out except that a non-liquid crystalline epoxy monomer (jER828, manufactured by Mitsubishi Chemical Corporation, a monomer different from that represented by Formula (I)) (hereinafter, also referred to as “resin 7”) was used instead of the resin 2 used in the Example 1.

### Comparative Example 2

The same operation as in Example 1 was carried out except that the speed of the spin coating was changed to 200 rotations/min.

### Comparative Example 3

The same operation as in Example 1 was carried out except that the epoxy resin composition was spin coated on a release film (MELINEX S (brand name), manufactured by DuPont Company) instead of the glass substrate used in Example 1, cured, and then physically peeled off from the release film, to obtain an epoxy resin cured film.

TABLE 1

| | | | | | Liquid | | Thermal | Average |
|---|---|---|---|---|---|---|---|---|
| | Prepolymer- | Epoxy | | | Crystal | Direction Of | Conductivity | Thickness |
| | Forming Agent | Resin | Solvent | Curing Agent | Structure | Orientation | (W/mK) | (μm) |
| Example 1 | 4,4′-biphenol | Resin2 | — | 3,3'- | presence | vertical direction | 2.2 | 6 |
| Example 2 | hydroquinone | Resin3 | — | diaminodiphenyl | presence | vertical direction | 2.3 | 6 |
| Example 3 | 4,4′-biphenol | Resin5 | — | sulfone | presence | vertical direction | 2.2 | 6 |
| Example 4 | hydroquinone | Resin6 | — | | presence | vertical direction | 2.3 | 6 |
| Example 5 | 4,4′-biphenol | Resin2 | tetrahydrofuran | | presence | vertical direction | 4.1 | 3 |
| Example 6 | hydroquinone | Resin3 | tetrahydrofuran | | presence | vertical direction | 3.8 | 3 |
| Example 7 | 4,4′-biphenol | Resin5 | tetrahydrofuran | | presence | vertical direction | 4.4 | 3 |
| Example 8 | hydroquinone | Resin6 | — | | presence | vertical direction | 4.5 | 3 |
| Comparative | — | Resin7 | — | | absence | absence | 0.2 | 6 |
| Example 1 | | | | | | | | |
| Comparative | 4,4′-biphenol | Resin2 | — | | presence | vertical direction | 0.8 | 45 |
| Example 2 | | | | | | | | |
| Comparative | 4,4′-biphenol | Resin2 | — | | presence | horizontal direction | 0.3 | 6 |
| Example 3 | | | | | | | | |

The symbol “—” shown in the column of the prepolymer-forming agent in Table 1 indicates that a prepolymer has not been formed.
The symbols “—” shown in the column of the solvent in Table 1 indicate that no solvent has been used.

As shown in Table 1, it is thought that the epoxy resin cured film prepared in Comparative Example 1 has a low thermal conductivity, because a liquid crystal structure has not been formed therein due to using a non-liquid crystalline epoxy resin. The epoxy resin cured film prepared in Comparative Example 2 is thought to have a low thermal conductivity, due to having a large film thickness. Further, the epoxy resin cured film prepared in Comparative Example 3 is thought to have a low thermal conductivity in the film thickness direction, because molecules are orientated horizontally.

In contrast, it is thought that the epoxy resin cured films prepared in Examples 1 to 8 have a high thermal conductivity, because a liquid crystal structure in which molecules are orientated in the vertical direction (film thickness direction) has been formed, and the film thickness is small, in each film.

All publications, patent applications, and technical standards mentioned in the present application are incorporated herein by reference to the same extent as if each individual publication, patent application, or technical standard was specifically and individually indicated to be incorporated by reference.

1. An epoxy resin cured film, comprising a liquid crystal structure in which molecules are orientated in a film thickness direction, and which has an average thickness of less than 8 μm.

2. The epoxy resin cured film according to claim 1, wherein the liquid crystal structure is a nematic structure or a smectic structure.

3. The epoxy resin cured film according to claim 1, comprising a cured product of an epoxy resin composition, the epoxy resin composition comprising: a liquid crystalline epoxy monomer capable of forming a cured product that includes a liquid crystal structure; and a curing agent.

4. The epoxy resin cured film according to claim 3, wherein the liquid crystalline epoxy monomer comprises a monomer represented by the following Formula (I): 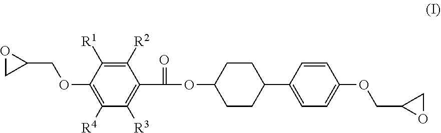
wherein, in Formula (I), each of R¹ to R⁴ independently represents a hydrogen atom or an alkyl group having from 1 to 3 carbon atoms.

5. The epoxy resin cured film according to claim 4, wherein the liquid crystalline epoxy monomer comprises a reaction product of the monomer represented by Formula (I) and at least one selected from the group consisting of hydroquinone and a biphenol.

6. The epoxy resin cured film according to claim 3, wherein the curing agent comprises an amine curing agent.

7. The epoxy resin cured film according to claim 3, wherein the epoxy resin composition further comprises a solvent.

8. The epoxy resin cured film according to claim 3, wherein a content of the liquid crystalline epoxy monomer with respect to a total solid content of the epoxy resin composition is from 5% by volume to 80% by volume.

9. The epoxy resin cured film according to claim 4, wherein the monomer represented by Formula (I) comprises at least one selected from the group consisting of 4-{4-(2,3-epoxypropoxy)phenyl}cyclohexyl=4-(2,3-epoxypropoxy)benzoate and 4-{4-(2,3-epoxypropoxy)phenyl}cyclohexyl=4-(2,3-epoxypropoxy)-3-methyl benzoate.

10. The epoxy resin cured film according to claim 5, wherein the biphenol is 4,4′-biphenol.

11. The epoxy resin cured film according to claim 6, wherein the amine curing agent is 3,3′-diaminodiphenyl sulfone.

12. A method of producing the epoxy resin cured film according to claim 1, the method comprising:
forming a film having an average thickness of less than 8 μm at a temperature of 150° C. or lower, using an epoxy resin composition comprising: a liquid crystalline epoxy monomer capable of forming a cured product that includes a liquid crystal structure; and a curing agent; and
curing the film at a curing temperature of 200° C. or lower.
